(19) United States
(12) Patent Application Publication
(10) Pub. No.: US 2019/0351776 A1
(43) Pub. Date: Nov. 21, 2019

(54) VEHICLE START UNDER COLD TEMPERATURES USING SELF-HEATING BATTERY

(71) Applicant: GM GLOBAL TECHNOLOGY OPERATIONS LLC, Detroit, MI (US)

(72) Inventors: Jiang L. Du, Beaverton, OR (US); Donald K. Grimm, Utica, MI (US); Zhiqiang Yu, Pudong (CN); Haijing Liu, Shanghai (CN)

(21) Appl. No.: 15/982,532

(22) Filed: May 17, 2018

(51) Int. Cl. B60L 11/18; B60W 10/08; B60W 10/26; B60K 6/485

(52) U.S. Cl. CPC B60L 11/1875; B60W 10/08; B60L 2240/545; B60K 6/485; B60W 10/26

(57) ABSTRACT

One or more vehicle systems and methods of operating a vehicle using wireless communications are disclosed. One method includes establishing a temperature threshold for a cold-start of the vehicle; receiving a remote vehicle start request via a wireless signal, wherein the remote vehicle start request is a request to start a motor of the vehicle; when the remote vehicle start request is received, indicating that the motor of the vehicle has failed to start; communicating with a self-heating battery on-board the vehicle the indication that the motor of the vehicle has failed to start; obtaining a temperature of a working battery on-board the vehicle or a temperature around the vehicle; when the temperature obtained of the working battery or around the vehicle is less than or equal to the temperature threshold for the cold-start of the vehicle, operating the self-heating battery to heat the working battery; and sending another vehicle start request wherein the another vehicle start request starts the motor of the vehicle.

### INTRODUCTION

The present disclosure relates to vehicle motors and, more particularly, to systems and methods of starting vehicle motors or engines under cold temperatures.

Upon starting a vehicle, a battery for the vehicle typically supplies the energy to start the vehicle's motor, ignition system, or engine, depending on the type of vehicle. Under cold temperatures, some batteries have reduced energy and power outputs of their electrochemical cells, making it difficult to start the vehicle.

### SUMMARY

As discussed briefly in the Introduction, a vehicle's battery supplies the energy and power outputs to start the vehicle. If the battery is having difficulty starting the vehicle, possibly due to cold environmental temperatures, a battery management system (BMS) can assist in operating the battery so that the energy and power outputs are increased. In this way, the BMS improves the rate at which the vehicle will start and decreases or prevents a vehicle starter fault. Additionally, the BMS can operate the battery if the vehicle is being started from a remote location, such as with key fob or personal mobile device.

In one particular example, the battery has a working component and a self-heating component. The working component, or power generating component, supplies the energy and power outputs to start the vehicle. When the vehicle is in cold temperatures, the BMS operates the self-heating component to supply heat to the working component in order to increase the energy and power outputs of the working component. The BMS performs a number of process steps in order to determine the temperature either of the working component or the temperature around the vehicle and how to operate the self-heating component to increase the energy and power outputs of the working component. This increases the rate at which the vehicle will start.

According to an aspect of the disclosure, one method of operating a vehicle using wireless communications includes establishing a temperature threshold for a cold-start of the vehicle; receiving a remote vehicle start request via a wireless signal, wherein the remote vehicle start request is a request to start a motor of the vehicle; when the remote vehicle start request is received, indicating that the motor of the vehicle has failed to start; communicating with a self-heating battery on-board the vehicle the indication that the motor of the vehicle has failed to start; obtaining a temperature of a working battery on-board the vehicle or a temperature around the vehicle; when the temperature obtained of the working battery or around the vehicle is less than or equal to the temperature threshold for the cold-start of the vehicle, operating the self-heating battery to heat the working battery; and sending another vehicle start request wherein the another vehicle start request starts the motor of the vehicle.

Optionally, the methods described herein include monitoring the vehicle for the remote vehicle start request with a communication module of the self-heating battery and idling the communication module of the self-heating battery until the remote vehicle start request via the wireless signal is received. In one example, the monitoring step occurs before the step of receiving a remote vehicle start request via a wireless signal. The step of receiving a remote vehicle start request includes the wireless signal coming from one or more remote devices selected from the group consisting of a personal mobile device, key fob, processor, call center, and a combination thereof

When the temperature obtained of the working battery or around the vehicle is greater than the temperature threshold for the cold-start of the vehicle, the method further includes idling a communication module of the self-heating battery until another remote vehicle start request is received, in one example. Additionally or alternatively, when the temperature obtained around the vehicle is less than or equal to the temperature threshold for the cold-start of the vehicle, the step of operating the self-heating battery includes activating the self-heating battery.

Optionally, the step of establishing a temperature threshold for a cold-start of the vehicle includes the temperature threshold having two or more temperatures so that a first temperature of the two or more temperatures is less than room temperature and a second temperature of the two or more temperatures is less than the first temperature. Any of the described methods optionally include calculating a wait time based on the temperature obtained and the temperature threshold and operating the self-heating battery for the calculated wait time. In one example, the temperature of the working battery or the temperature around the vehicle is approximately −30° C., and the calculated wait time is approximately 90 seconds. After any or all of the above steps, the method optionally includes sending another vehicle start request after expiry of the calculated wait time.

Until the vehicle starts, the method optionally includes repeating any or all of the above steps, such as communicating with a self-heating battery on-board the vehicle the indication that the motor of the vehicle has failed to start; obtaining a temperature of a working battery on-board the vehicle or a temperature around the vehicle; when the temperature obtained of the working battery or around the vehicle is less than or equal to the temperature threshold for the cold-start of the vehicle, calculating a wait time based on the temperature obtained and the temperature threshold; operating the self-heating battery for the calculated wait time to heat the working battery; and after expiry of the calculated wait time, sending another vehicle start request. Once the vehicle starts, the method optionally includes operating a vehicle system power mode after the step of sending another vehicle start request.

In any of the methods described herein, the self-heating battery optionally includes a battery selected from the group consisting of a lithium-ion, lithium air, solid state, sodium ion, and a combination thereof. The self-heating battery optionally has a conductive foil including an extended and uncoated portion that is extended outside of a foil area of the self-heating battery and uncoated with both of an anode and cathode material. The motor of the vehicle optionally includes an electric driving motor or a starter motor.

According to another aspect of the disclosure, another method of operating a vehicle using wireless communication includes: (a) establishing a temperature threshold for a cold-start of the vehicle wherein the temperature threshold includes two or more temperatures so that a first temperature of the two or more temperatures is less than or equal to −20° C. and a second temperature of the two or more temperatures is less than the first temperature; (b) receiving a remote vehicle start request via a wireless signal, wherein the remote vehicle start request is a request to start a motor of the vehicle; (c) when the remote vehicle start request is received, indicating that the motor of the vehicle has failed to start; (d) communicating with a self-heating battery on-board the vehicle the indication that the motor of the vehicle has failed to start; (e) obtaining a temperature of a working battery on-board the vehicle or a temperature around the vehicle with a controller area network of the vehicle or a temperature sensor in communication with the vehicle; (0 when the temperature obtained of the working battery or around the vehicle is less than or equal to either of the first and second temperatures of the temperature threshold, calculating a wait time based on the temperature obtained and the first and second temperatures; (g) operating the self-heating battery to heat the working battery for the calculated wait time; and (h) after expiry of the calculated wait time, sending another vehicle start request. This method optionally includes repeating steps (d) to (h) until the motor of the vehicle has started. This aspect also additionally or alternatively include any of the other method steps described herein.

In one specific example, the second temperature is equal to or less than −30° C. In another specific example, the temperature of the working battery or the temperature around the vehicle is approximately −30° C. and the calculated wait time is approximately 90 seconds.

According to another aspect of the disclosure, another method of using wireless communication to start a vehicle in a low temperature environment includes the vehicle having a battery for starting a motor of the vehicle. The battery has a working component and a self-heating component. The vehicle further has a battery management system adapted (i) to receive and activate a motor-starting command, (ii) to measure a present temperature of the battery, and (iii) to determine its current state of charge. The method includes: the battery management system receiving a wireless command to start the motor and then determining that a capacity of the working component at the present temperature is too low to start vehicle motor; the battery management system sending a return wireless signal signifying that the working component must be heated by the self-heating component before it can start the vehicle motor, and executing a command to start operation of the self-heating component; and the battery management system, after determining that the working component has been heated to a suitable operating temperature, issuing a wireless signal inviting a new wireless command to start the motor of the vehicle. In one aspect, this aspect additionally or alternatively include any of the other method steps described herein.

Other aspects and features will be apparent from the following figures and examples.

### BRIEF DESCRIPTION OF THE DRAWINGS

One or more aspects of the disclosure will hereinafter be described in conjunction with the appended drawings, wherein like designations denote like elements, and wherein:

FIG. 1A is a schematic view of a communication system for a vehicle, according to one example;

FIG. 1B is a schematic view of a battery of the vehicle of FIG. 1A, according to one example;

FIG. 2 is a block diagram of various vehicle hardware of the vehicle of FIG. 1A and how the various vehicle hardware communicates, according to one example; and

FIG. 3 is block diagram of a method of operating the vehicle of FIG. 1A, according to one example.

### DETAILED DESCRIPTION

A vehicle can have one or more batteries, depending on the type of vehicle (e.gs., gasoline powered, electric, hybrid, etc.). At least one of these batteries typically supplies energy to start the vehicle's main propulsion system. This battery is typically the main battery of the vehicle, but those of ordinary skill in the art will understand that the discussion herein can relate to any battery used in a vehicle. In a gasoline powered vehicle, the main battery (e.g., a lead-acid battery) supplies the initial energy needed to start (1) a starter motor that will start the engine and (2) an ignition system that supplies a spark to the engine. In an electric vehicle, the main battery (e.gs., a lithium-ion, lithium air, solid state, or sodium-ion battery) supplies the initial energy needed to start the electric driving motor, for example, to drive the wheels of the vehicle. A hybrid vehicle will typically have a combination of the above-described components as it operates both on electric and gasoline power. It will be appreciated that the starter motor used to start the engine could also be an electric motor, or it could be pneumatic, hydraulic, or the like.

The vehicle's battery is often initiated by a signal, for example, by inserting a key into the vehicle. The signal to start the vehicle can also come from a remote device, such as a key fob or personal mobile device. In one particular example, the vehicle may be equipped with a BMS and method to enable a remote start of the vehicle, for example, from a location remote to the vehicle via a wireless signal from the remote device.

In any of the above-described scenarios, vehicles located in particularly cold environments, such as with cold temperatures, may not be able to start because the battery can have reduced energy and power outputs of its electrochemical cells under these cold temperatures. The reduced energy and power outputs may be insufficient to start the vehicle's motor, engine, or ignition system. One method of increasing the energy and power outputs of the battery is to heat the battery. For example, a self-heating battery, either separate from or part of the main battery, can assist in increasing the energy and power outputs needed to start the vehicle.

A self-heating battery is a battery that has the ability to raise an operating temperature of the battery in order to increase the energy and power outputs of the battery, without relying on the surrounding environment. As an illustrative example, the operating temperature of the battery may be approximately room temperature. For purposes of this disclosure, room temperature is between approximately 20° C. to approximately 25° C. Also, for purposes of this disclosure, “about” or “approximately” mean that a given quantity is within 10%, preferably within 5%, more preferably within 1%, of a comparison value (e.g., room temperature is within 1% of 20° C.).

Illustrative self-heating batteries and related processes are disclosed in International Patent Application No. PCT/US2017/023506 (Docket P037797-CSL-SDJ), which is assigned to the assignee hereof, has one or more common inventors, and is incorporated herein by reference. In one example herein, a self-heating cell of a battery has one or more extended and/or uncoated portions of its conductive foil that has a higher electrical resistance when compared to other portions of the conductive foil. For example, the self-heating cell has an anode with a first extended and uncoated portion and a cathode with a second extended and uncoated portion. The one or more extended and/or uncoated portions can extend outside of a foil area of the self-heating cell and/or can be uncoated with both of an anode and cathode material. The one or more extended and/or uncoated portions are in electrical contact with a working cell of the battery so that the self-heating cell can generate and transfer heat to the working cell by way of the one or more extended and/or uncoated portions.

In one example, the self-heating cell may be able to increase the operating temperature of the working cell by approximately 10° C. The self-heating cell may be operated multiple times to increase the operating temperature of the working cell by approximately 10° C. during each operation. It will be understood that the above discussion of a self-heating battery is just one example, and other batteries and/or methods may be used to increase the operating temperature of the vehicle's battery.

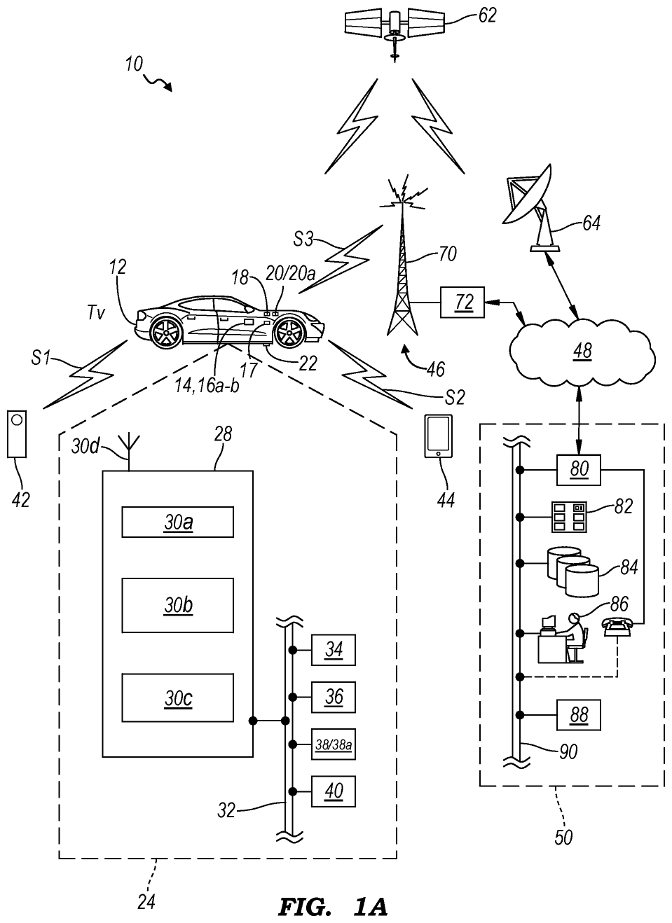

FIG. 1A is a schematic view of an operating environment that includes a mobile vehicle communication system 10 with several of the vehicle components discussed above. This exemplary mobile vehicle communication system (“communication system”) 10 can implement the method(s) disclosed herein, and these vehicle components can be combined to form the battery management and/or vehicle starter system. The communication system 10 generally includes a vehicle 12, one or more wireless carrier systems 46, a land communications network 48, and a call center 50. It should be understood that the disclosed method(s) can be used with any number of different systems and are not specifically limited to the operating environment shown here. The following paragraphs provide a brief overview of one such communication system 10; however, other systems not shown here could employ the disclosed method(s) as well.

Vehicle 12 is depicted as a passenger car, but it should be appreciated that any other vehicle including motorcycles, trucks, sports utility vehicles (SUVs), recreational vehicles (RVs), marine vessels, aircraft, etc., can also be used. The vehicle 12 can accommodate vehicle occupants inside its cab, which can be a driver or passengers. As discussed above, vehicle 12 could be a gasoline powered, electric, or hybrid vehicle. In any case, vehicle 12 could be equipped with one or more batteries, for example, a battery 14. The battery 14 can have various cells, including a self-heating cell or battery 16a and a working cell or battery 16b. The self-heating battery 16a can provide heat to the working battery 16b, while the working battery 16b provides the energy and power outputs to start the vehicle 12. The self-heating battery 16a and the working battery 16b could also be separate batteries in the vehicle 12, or could be combined into one battery 14 as shown in FIG. 1A.

FIG. 1B illustrates a schematic view of one configuration of the self-heating battery 16a and the working battery 16b of the battery 14, providing further detail. For example, the self-heating battery 16a may be packaged in a container 16c, which contains a conductive foil (not shown). An uncoated anode current collector tab 16d, indicating a negative charge, extends from an anode portion of the conductive foil and a top side of the container 16c. An uncoated cathode current collector tab 16e, indicating a positive charge, extends from a cathode portion of the conductive foil and a top side of the container 16c. The tabs 16d, 16e can have a higher electrical resistance than other portions of the conductive foil

The working battery 16b is depicted side-by-side and in electrical contact with the self-heating battery 16a. The working battery 16b has its own container 16f, and an anode current collector tab 16h and a cathode current collector tab 16g extend from the top of the container 16f. The working battery 16b can produce an electrical current for powering, for example, the starting motor, electric driving motor, and/or other electric power consuming devices in the vehicle 12.

Returning to FIG. 1A, in a gasoline powered vehicle, the battery 14 could include a lead acid battery, and could provide the energy and power to start a starter motor 17 and/or an ignition system 18 that can, in turn, start an engine 20. In an electric vehicle, the battery 14 could include a lithium ion, lithium air, solid state, and/or sodium ion battery, and could provide the energy and power to start an electric driving motor 20a that can also interact with a controller (not depicted). The vehicle 12 can also include various optional sensors, including an optional temperature sensor 22. The temperature sensor 22 can be used to sense or obtain a temperature of the working battery 16b or a temperature around the vehicle T_{V}. The temperature around the vehicle T_{V} can be an ambient temperature of the surrounding environment. The temperature of the working battery 16b can be the same or substantially the same as the temperature around the vehicle T_{V} and the ambient temperature, especially if the vehicle 12 is off and the working battery 16b is not being heated or generating heat itself. However, the temperature of the working battery 16b is not necessarily the same as the temperature around the vehicle T_{V}, for example, due to wind, shade, or the like. It will be appreciated that the vehicle's systems can sense or obtain either of the temperature of the working battery 16b or the temperature around the vehicle T_{V} in order to determine if the self-heating battery 16a should be operated to heat the working battery 16b.

In addition to the vehicle hardware discussed above, the vehicle 12 can include various software to operate the vehicle hardware. For example, the vehicle 12 can include various vehicle electronics 24, shown generally in FIG. 1A. The vehicle electronics 24 can include a telematics unit 28 for connecting the vehicle's various hardware and software components. The telematics unit 28 can be connected directly to some hardware, whereas other hardware is indirectly connected using one or more network connections, such as a communications bus 32. Examples of suitable network connections include a controller area network (CAN), a media oriented system transfer (MOST), a local interconnection network (LIN), a local area network (LAN), and other appropriate connections such as Ethernet or others that conform with known ISO, Society of Automotive Engineers (SAE) and Institute of Electrical and Electronics Engineers (IEEE) standards and specifications, to name but a few.

The telematics unit 28 is itself a vehicle system module (VSM) and can be implemented as an OEM-installed (embedded) or aftermarket device that is installed in the vehicle and that enables wireless voice and/or data communication over the wireless carrier system 46 and via wireless networking. This enables the vehicle to communicate with the call center 50, other telematics-enabled vehicles, or some other entity or device. The telematics unit can use radio transmissions to establish a communications channel (a voice channel and/or a data channel) with the wireless carrier system 46 so that voice and/or data transmissions can be sent and received over the channel. By providing both voice and data communication, the telematics unit 28 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 50) and data communication (e.g., to receive a remote vehicle start request from the call center 50), the system can utilize a single call over a voice channel and switch as needed between voice and data transmission over the voice channel, and this can be done using techniques known to those skilled in the art.

According to one aspect, the telematics unit 28 utilizes cellular communication according to either GSM, CDMA, or LTE standards and thus includes a standard cellular chipset 30a for voice communications like hands-free calling, a wireless modem for data transmission, an electronic processing device 30b, one or more digital memory devices 30c, and a dual antenna 30d. It should be appreciated that the modem can either be implemented through software that is stored in the telematics unit and is executed by processor 30b, or it can be a separate hardware component located internal or external to telematics unit 28. The modem can operate using any number of different standards or protocols such as LTE, EVDO, CDMA, GPRS, and EDGE. Wireless networking between the vehicle and other networked devices can also be carried out using the telematics unit 28. For this purpose, telematics unit 28 can be configured to communicate wirelessly according to one or more wireless protocols, including short range wireless communication (SRWC) such as any of the IEEE 802.11 protocols, WiMAX, ZigBee™, Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

The processor 30b can be any type of device capable of processing electronic instructions including microprocessors, microcontrollers, host processors, controllers, vehicle communication processors, and application specific integrated circuits (ASICs). It can be a dedicated processor used only for telematics unit 28 or can be shared with other vehicle systems. The processor 30b executes various types of digitally-stored instructions, such as software or firmware programs stored in the memory 30c, which enable the telematics unit to provide a wide variety of services. For instance, the processor 30b can execute programs or process data to carry out at least a part of the method discussed herein.

The telematics unit 28 can be used to provide a diverse range of vehicle services that involve wireless communication to and/or from the vehicle 12. Such services include: turn-by-turn directions; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback to name a few. Furthermore, it should be understood that at least some of the modules discussed herein could be implemented in the form of software instructions saved internal or external to telematics unit 28, they could be hardware components located internal or external to the telematics unit 28, or they could be integrated and/or shared with each other or with other systems located throughout the vehicle, to cite but a few possibilities.

Connected to the telematics unit 28 is the communications bus 32, which couples the telematics unit 28 to a battery communication module 34, an ignition module 36, an engine module 38 or an electric driving motor module 38a, and/or a temperature module 40. These modules can be programmed to run the BMS and/or vehicle system diagnostic tests. For example, the engine module 38 can be an engine control module (ECM) that controls various aspects of engine operation such as fuel ignition, ignition timing, engine fault or failure in a gasoline powered vehicle, as will be discussed in further details herein. Optionally, the ECM is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in the vehicle 12, as numerous others are also possible.

The temperature module 40 can be programmed to include data regarding temperature ranges for the vehicle 12 to start. For example, the temperature module 40 can include or establish a temperature threshold for a cold-start of the vehicle 12. Under the temperature threshold, the battery 14, including the working battery 16b, of the vehicle 12 may not have sufficient energy and power to start the starter motor 17, engine 20, or electric driving motor 20a. In this scenario, the vehicle 12 may have to operate one or more methods in order to start the starter motor 17, engine 20, or electric driving motor 20a. Establishing the temperature threshold for the cold-start of the vehicle 12 may include the temperature threshold having two or more temperatures so that a first temperature T1 of the two or more temperatures is less than room temperature and a second temperature T2 of the two or more temperatures is less the first temperature T1. In a specific aspect, the first temperature T₁ can be approximately −20° C. The second temperature T2 can be approximately −30° C. These temperatures can be below the normal operating temperatures of the working battery 16b. The first and second temperatures T1, T2, or any other stored temperature of the temperature threshold, can specify how long to operate the self-heating battery 16a, as will be discussed in further detail below.

Returning to the communication system 10, the wireless carrier system 46 can be a cellular telephone system that includes a plurality of cell towers 70 (only one shown), one or more mobile switching centers (MSCs) 72, as well as any other networking components required to connect wireless carrier system 46 with the land network 48. Each cell tower 70 includes sending and receiving antennas and a base station, with the base stations from different cell towers being connected to the MSC 72 either directly or via intermediary equipment such as a base station controller. The cellular system 46 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with the wireless system 46. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using the wireless carrier system 46, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of the wireless carrier system 46.

The land network 48 may be a conventional land-based telecommunications network that is connected to one or more landline telephones and connects the wireless carrier system 46 to the call center 50. For example, the land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, the call center 50 need not be connected via the land network 48, but could include wireless telephony equipment so that it can communicate directly with a wireless network, such as the wireless carrier system 46.

The call center 50 is designed to provide the vehicle electronics 24 with a number of different system back-end functions and, according to example shown here, generally includes one or more switches 80, servers 82, databases 84, live advisors 86, as well as an automated voice response system (VRS) 88, all of which are known in the art. These various call center components can be coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1A. VoIP and other data communication through the switch 80 is implemented via a modem (not shown) connected between the switch 80 and network 90. Data transmissions are passed via the modem to the server 82 and/or database 84. The database 84 can store account information such as subscriber authentication information, vehicle identifiers, temperature data, profile records, behavioral patterns, and other pertinent subscriber information. Data transmissions may also be conducted by wireless systems, such as 802.11x, GPRS, and the like. Although the illustrated aspect has been described as it would be used in conjunction with a manned call center 50 using live advisor 86, it will be appreciated that the call center can instead utilize VRS 88 as an automated advisor or, a combination of VRS 88 and the live advisor 86 can be used.

In order to start the vehicle 12 from a remote location, one or more remote devices can be used. For example, a key fob 42 can send a wireless signal 51 to the vehicle 12 and the engine module 38 to start the vehicle 12. Additionally or alternatively, a personal mobile device 44 can send a wireless signal S2 to the vehicle 12 and the engine module 38. Even the call center 50 can be used to send a wireless signal S3 to the vehicle 12 and the engine module 38 to start the vehicle 12. Other possible remote devices include a processor, computer, or any combination of the above. Regardless of what device sends the wireless signal, if the temperature of the working battery 16b or the temperature around the vehicle T_{V} is below the operating temperature of the working battery 16b, the working battery 16b may not be able to start the vehicle 12.

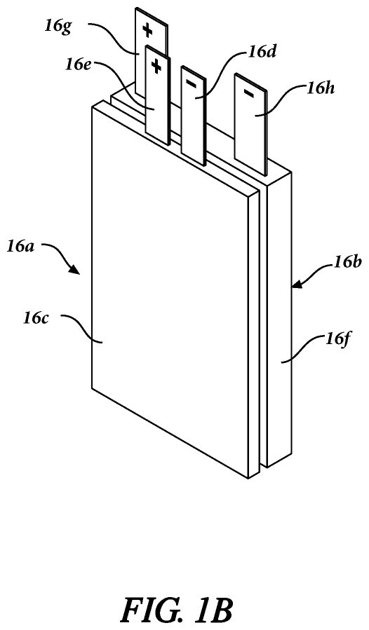

Under cold temperatures, the vehicle 12 may need to use its various hardware and software to heat the battery 14, including working battery 16b, to its operating temperature. FIG. 2 depicts an illustrative block diagram of how the vehicle 12 may operate and/or start under cold temperatures or in a low temperature environment. For example, one or more of the key fob 42, the personal mobile device 44 running an application 45 to remotely start the vehicle 12, and/or the call center 50 may send a remote vehicle start request via a wireless signal (S1, S2, and/or S3) to start the vehicle 12. In one aspect, the personal mobile device 44 can communication with the call center 50 to send the wireless signal. The vehicle 12 can receive the remote vehicle start request by way of the various vehicle hardware and software, and communicate it to the battery communication module 34, the engine module 38, or the electric driving motor module 38a.

When the remote vehicle start request is received, and the operating temperature is sufficient, the vehicle 12 can start as intended. In this case, the vehicle's systems can communicate with the self-heating battery 16a on-board the vehicle 12 that the motor 17/20a of the vehicle 12 has started. It is also possible that the signal or request to start the vehicle 12 is not necessarily remote, but rather received within the vehicle 12, such as by inserting a key into the vehicle or pushing a button to start the vehicle.

The vehicle's battery management system can be adapted (i) to receive and activate a motor-starting command, (ii) to measure a present temperature of the battery 14, and (iii) to determine its current state of charge, as is discussed in further detail herein. The battery management system can receiving a wireless signal (e.gs., S1-3) or command to start the motor 17/20a and then determine that a capacity of the working component of the battery 14 at the present temperature is too low to start vehicle motor 17/20a.

If the operating temperature is too low, the vehicle 12 may indicate that the motor 17/20a of the vehicle 12 failed to start, by way of an indication 52. The vehicle's systems can communicate with the self-heating battery 16a on-board the vehicle 12 the indication 52 that the motor 17/20a of the vehicle 12 has failed to start.

When the battery communication module 34 or the engine module 38 indicates that the motor 17/20a has failed to start, the vehicle's systems can obtain the temperature of the working battery 16b or the temperature around the vehicle T_{V} with any of the controller area network (CAN), local area network (LAN), and/or with the temperature sensor 22 in communication with the vehicle 12. The CAN can be a single wire CAN as part of the vehicle 12. In one example, any CAN bus or LAN bus can be coupled to or in communication with a temperature sensor that is wired, wireless, connected to the vehicle 12, or remote from the vehicle 12. The temperature sensor can also be connected to or in communication with the any vehicle electronics, including an electronic control unit (ECU). Additionally, the temperature sensor can sense or obtain the temperature of the working battery 16b or the temperature around the vehicle T_{V}. The temperature of the working battery 16b or the temperature around the vehicle T_{V} can be accessible, directly or indirectly, by software code implemented on the vehicle electronics, including the ECU, or published on the CAN or LAN bus.

The temperature sensor in communication with the CAN or LAN bus can be the exemplary temperature sensor 22, or the exemplary temperature sensor 22 can communicate with other vehicle electronics 24 and not directly with the CAN or LAN bus. Additionally, the temperature sensor 22 can be on-board the vehicle 12 or remote and in communication with the vehicle 12.

It will be appreciated that various other known methods of obtaining the temperature of the working battery 16b or the temperature around the vehicle T_{V} can be utilized herein, such as receiving them from the call center 50. The vehicle's systems, including the battery communication module 34, can compare the temperature of the working battery 16b or the temperature around the vehicle T_{V} with the stored temperature threshold for the cold-start in order to determine if the surrounding environment is too cold to start the motor 17/20a.

If the temperature of the working battery 16b or the temperature around the vehicle T_{V} is greater than the temperature threshold, then the operating temperature of the working battery 16b may not be the reason the vehicle 12 failed to start. Under these conditions, the vehicle's systems, including the battery communication module 34, can go into a stand-by state, or idle, until another remote vehicle start request is received. However, if the temperature of the working battery 16b or the temperature around the vehicle T_{V} is less than or equal to the temperature threshold, the vehicle 12 can start a sequence of process steps to heat up the working battery 16b.

The battery management system can send a return wireless signal signifying that the working component must be heated by the self-heating component before it can start the vehicle motor 17/20a, and executing a command to start operation of the self-heating component.

When the temperature of the working battery 16b or the temperature around the vehicle T_{V} is less than the temperature threshold, the vehicle's systems can activate a self-heating function of the battery 16a. This can include using the self-heating battery 16a to heat the working battery 16b. The vehicle's systems can calculate a wait time based on a comparison between the temperature of either of the working battery 16b or the temperature around the vehicle T_{V} and the temperature threshold, including the two or more temperatures. For example, the temperature module 40 can calculate and/or provide a wait time based on how cold the surrounding environment is, and how long to operate the self-heating battery 16a, until the working battery 16b is sufficiently heated. In one example, if the obtained temperature is −30° C., the calculated wait time is approximately 90 seconds. In another example, if the obtained temperature is −35° C., the calculated wait time is approximately 95 seconds. It is possible for the temperature threshold to include as many temperatures needed so that one temperature will always match the obtained temperature. Of course, it is also possible that if the obtained temperature does not directly match with a stored temperature of the temperature threshold, the vehicle's systems can estimate how long to operate the self-heating battery based on what temperatures are stored.

After the calculated wait time expires, the vehicle's systems can retry to start the vehicle 12, as indicated with arrow 54, including sending another vehicle start request either from the vehicle's systems or from a remote source such as the call center 50. The battery management system, after determining that the working component has been heated to a suitable operating temperature, can issue a wireless signal (e.g., with arrow 54) inviting a new wireless command to start the motor 17/20a of the vehicle 12. If the working battery 16b is sufficiently heated, the vehicle 12 will start.

If the working battery 16b is still not sufficiently heated, the vehicle's system can repeat any or all of the above steps. In one example, these repeated steps include: communicating with a self-heating battery on-board the vehicle the indication that the motor of the vehicle has failed to start; obtaining a temperature of the working battery or a temperature around the vehicle, possibly with a controller area network of the vehicle or a temperature sensor in communication with the vehicle; when the temperature obtained of the working battery or around the vehicle is less than or equal to the temperature threshold for the cold-start of the vehicle, calculating a wait time based on the temperature obtained of the working battery or around the vehicle and the two or more temperatures of the threshold temperature; operating the self-heating battery for the calculated wait time, for example, to heat the working battery on-board the vehicle; and after expiry of the calculated wait time, sending another vehicle start request. If the working battery 16b is sufficiently heated, the vehicle 12 will start.

Once the vehicle 12 has started, the vehicle's systems, including the engine module 38 or the electric driving motor module 38a, can operate a vehicle system power mode of the vehicle 12 because all systems may be fully operational. Additionally or alternatively, if any part of the battery 14, including the self-heating battery 16a or the working battery 16b, could be recharged, as indicated with arrow 56, the vehicle's systems can recharge the battery 14. In one example, the battery 14 can be recharged after the vehicle has been started, including running the engine 20 or motor 20a for at least two minutes. Recharging the battery 14 can increase the charge so that it is at approximately 100% state of charge in order to operate as intended, such as for the next self-heating event under the cold temperatures. As discussed above, the self-heating battery 16a could include or be part of a lead acid, lithium-ion, lithium air, solid state, and/or sodium-ion battery, and it could include a self-heating cell in electrical contact with a working cell or battery 16b for transferring heat to the working battery 16b. The motor could be the starter motor 17 or the electric driving motor 20a.

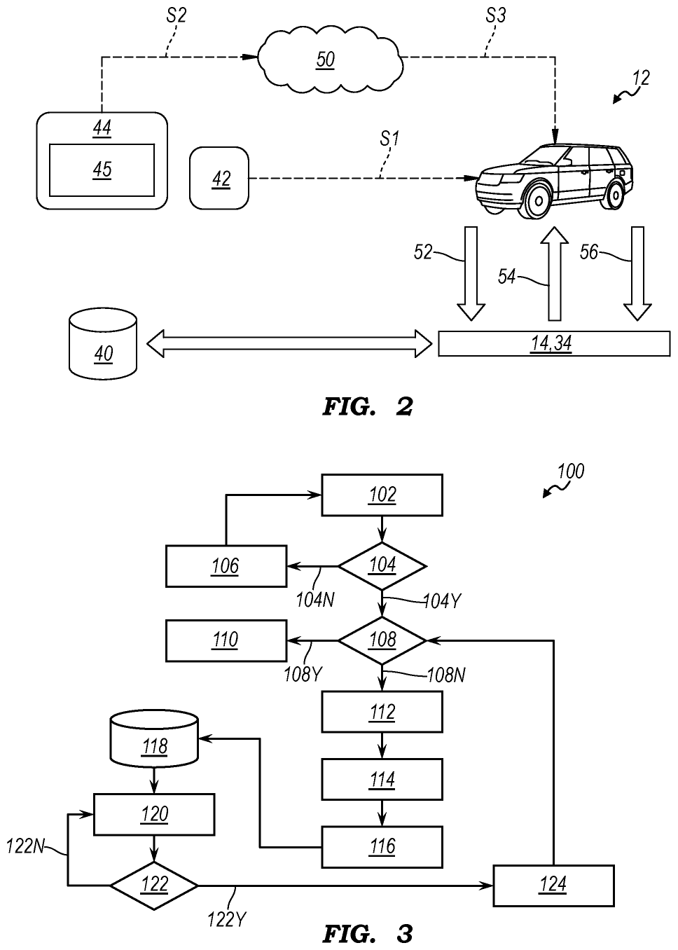

FIG. 3 is a block diagram 100 that depicts an illustrative method of operating the vehicle 12. In box 102, the vehicle's systems, including the battery communication module, can monitor the vehicle for the remote vehicle start request. Monitoring the vehicle can include periodically, sporadically, or at another interval of time requesting the vehicle's start status, including requesting various parameter identification from the CAN or other vehicle components. In box 104, the method includes determining if the vehicle has received the remote vehicle start request. With arrow 104N, if the remote vehicle start request is not received, the vehicle's systems can idle or sleep, as shown in box 106, until the remote vehicle start request is received. With arrow 104Y, the request is received. At this point, the method includes indicating if the motor has started in box 108. With arrow 108Y, the motor has started. If the motor starts, the method can idle, sleep, or end in box 110. With arrow 108N, the method includes indicating that the motor of the vehicle has failed to start.

If the motor fails to start, the method can include obtaining a temperature of the working battery or a temperature around the vehicle in box 112. At any point in the method, the vehicle's systems can establish a temperature threshold for a cold-start of the vehicle wherein the temperature threshold comprises two or more temperatures so that a first temperature of the two or more temperatures is less than or equal to room temperature and a second temperature of the two or more temperatures is less than the first temperature. In one example, the first temperature can be less than or equal to −20° C. to −30° C.

In box 114, the method can include activating the self-heating battery. If the temperature obtained of the working battery or around the vehicle is greater than the first temperature, then the method can include idling the battery communication module until another remote vehicle start request is received. If the temperature obtained of the working battery or around the vehicle is below the temperature threshold, the method includes in box 116 calculating a wait time based on the temperature obtained and the first and second temperatures. Optionally, the step in box 114 of activating the self-heating battery could be performed after the step in box 116 of calculating the wait time based on the temperature obtained and/or before box 118.

Box 118 includes operating the self-heating battery for the calculated wait time, for example, to heat the working battery to its operating temperature. Until the wait time expires, the method can cycle through box 120, box 122, and arrow 122N to wait until the wait time expires. Once the wait time has expired in box 122, the method includes following arrow 122Y to box 124 to send another vehicle start request. If the vehicle still fails to start, the method can further include repeating the steps in boxes 108, 112, 114, 116, 118, 120, 122, and 124 until the motor has started. The method can be repeated as many times as needed until the motor has started.

While the above has been described in terms of components provided with the vehicle, it could also be provided as an additional or aftermarket kit that could be added to the vehicle at any time to address the cold-start conditions. It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular aspects and are not to be construed as limitations on the scope of the disclosure or on the definition of terms used in the claims, except where a term or phrase is expressly defined above. Various other aspects and various changes and modifications to the disclosed aspects will become apparent to those skilled in the art. All such other aspects, embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of operating a vehicle using wireless communications, the method comprising:
establishing a temperature threshold for a cold-start of the vehicle;
receiving a remote vehicle start request via a wireless signal, wherein the remote vehicle start request is a request to start a motor of the vehicle;
when the remote vehicle start request is received, indicating that the motor of the vehicle has failed to start;
communicating with a self-heating battery on-board the vehicle the indication that the motor of the vehicle has failed to start;
obtaining a temperature of a working battery on-board the vehicle or a temperature around the vehicle;
when the temperature obtained of the working battery or around the vehicle is less than or equal to the temperature threshold for the cold-start of the vehicle, operating the self-heating battery to heat the working battery; and
sending another vehicle start request wherein the another vehicle start request starts the motor of the vehicle.

2. The method of claim 1, further comprising:
monitoring the vehicle for the remote vehicle start request with a communication module of the self-heating battery; and
idling the communication module of the self-heating battery until the remote vehicle start request via the wireless signal is received.

3. The method of claim 1, wherein the step of receiving a remote vehicle start request comprises the wireless signal coming from one or more remote devices selected from the group consisting of a personal mobile device, key fob, processor, call center, and a combination thereof

4. The method of claim 1, further comprising when the temperature obtained of the working battery or around the vehicle is greater than the temperature threshold for the cold-start of the vehicle, idling a communication module of the self-heating battery until another remote vehicle start request is received.

5. The method of claim 1, wherein the step of operating the self-heating battery comprises activating the self-heating battery.

6. The method of claim 1, wherein the step of establishing a temperature threshold for a cold-start of the vehicle comprises the temperature threshold including two or more temperatures so that a first temperature of the two or more temperatures is less than room temperature and a second temperature of the two or more temperatures is less than the first temperature.

7. The method of claim 1, further comprising calculating a wait time based on the temperature obtained and the temperature threshold.

8. The method of claim 7, wherein the step of obtaining a temperature of a working battery on-board the vehicle or a temperature around the vehicle includes the temperature of the working battery or the temperature around the vehicle being approximately −30° C., and the step of calculating a wait time includes the calculated wait time being approximately 90 seconds.

9. The method of claim 7, wherein the step of operating the self-heating battery includes operating the self-heating battery for the calculated wait time.

10. The method of claim 9, wherein the step of sending another vehicle start request including sending the another vehicle start request after expiry of the calculated wait time.

11. The method of claim 10, further comprising repeating the steps of:
communicating with a self-heating battery on-board the vehicle the indication that the motor of the vehicle has failed to start;
obtaining a temperature of a working battery on-board the vehicle or a temperature around the vehicle;
when the temperature obtained of the working battery or around the vehicle is less than or equal to the temperature threshold for the cold-start of the vehicle, calculating a wait time based on the temperature obtained and the temperature threshold;
operating the self-heating battery for the calculated wait time to heat the working battery; and
after expiry of the calculated wait time, sending another vehicle start request.

12. The method of claim 1, further comprising operating a vehicle system power mode after the step of sending another vehicle start request.

13. The method of claim 1, wherein the step of communicating with a self-heating battery includes the self-heating battery comprising a battery selected from the group consisting of a lithium-ion, lithium air, solid state, sodium ion, and a combination thereof.

14. The method of claim 13, wherein the self-heating battery has a conductive foil including an extended and uncoated portion that is extended outside of a foil area of the self-heating battery and uncoated with both of an anode and cathode material.

15. The method of claim 1, wherein the step of receiving a remote vehicle start request includes the motor of the vehicle being an electric driving motor or a starter motor.

16. A method of operating a vehicle using wireless communications, the method comprising:
(a) establishing a temperature threshold for a cold-start of the vehicle wherein the temperature threshold comprises two or more temperatures so that a first temperature of the two or more temperatures is less than or equal to −20° C. and a second temperature of the two or more temperatures is less than the first temperature;
(b) receiving a remote vehicle start request via a wireless signal, wherein the remote vehicle start request is a request to start a motor of the vehicle;
(c) when the remote vehicle start request is received, indicating that the motor of the vehicle has failed to start;
(d) communicating with a self-heating battery on-board the vehicle the indication that the motor of the vehicle has failed to start;
(e) obtaining a temperature of a working battery on-board the vehicle or a temperature around the vehicle with a controller area network of the vehicle or a temperature sensor in communication with the vehicle;
(f) when the temperature obtained of the working battery or around the vehicle is less than or equal to either of the first and second temperatures of the temperature threshold, calculating a wait time based on the temperature obtained and the first and second temperatures;
(g) operating the self-heating battery to heat the working battery for the calculated wait time; and
(h) after expiry of the calculated wait time, sending another vehicle start request.

17. The method of claim 16, further comprising repeating steps (d) to (h) until the motor of the vehicle has started.

18. The method of claim 16, wherein the step of establishing a temperature threshold includes the second temperature being equal to or less than −30° C.

19. The method of claim 16, wherein the step of obtaining a temperature of a working battery on-board the vehicle or a temperature around the vehicle includes the temperature of the working battery or the temperature around the vehicle being approximately −30° C., and wherein the step of operating the self-heating battery includes the calculated wait time being approximately 90 seconds.

20. A method of using wireless communication to start a vehicle in a low temperature environment, the vehicle comprising a battery for starting a motor of the vehicle, the battery comprising a working component and a self-heating component; the vehicle further comprising a battery management system adapted (i) to receive and activate a motor-starting command, (ii) to measure a present temperature of the battery, and (iii) to determine its current state of charge; the method comprising:
the battery management system receiving a wireless command to start the motor and then determining that a capacity of the working component at the present temperature is too low to start vehicle motor;
the battery management system sending a return wireless signal signifying that the working component must be heated by the self-heating component before it can start the vehicle motor, and executing a command to start operation of the self-heating component; and
the battery management system, after determining that the working component has been heated to a suitable operating temperature, issuing a wireless signal inviting a new wireless command to start the motor of the vehicle.
